(19) United States
(12) Patent Application Publication
(10) Pub. No.: US 2003/0032727 A1
(43) Pub. Date: Feb. 13, 2003

(54) Comb-shaped polymers having anionic functionality

(76) Inventors: Sridevi Narayan-Sarathy, Hilliard, OH (US); Laurence G. Dammann, Powell, OH (US)

Correspondence Address: David L. Hedden, ASHLAND INC., P.O. Box 2219, Columbus, OH, 43216, US

(21) Appl. No.: 09/901,249

(22) Filed: Jul. 9, 2001

(51) Int. Cl. C08F 8/00

(52) U.S. Cl. 525/100

(57) ABSTRACT

This invention relates to comb-shaped polymers having anionic functionality, which are synthesized by the free radical polymerization of a monomer(s) containing anionic functionality in the presence of a poly (mercaptosiloxane), which functions as a chain-transfer agent.

### CROSS-REFERENCE TO RELATED APPLICATIONS

Not Applicable.

### CLAIM TO PRIORITY

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

(1) Field of the Invention

This invention relates to comb-shaped polymers having anionic functionality, which are synthesized by the free radical polymerization of a monomer(s) containing anionic functionality in the presence of a poly (mercaptosiloxane), which functions as a chain-transfer agent.

(2) Description of the Related Art

Low molecular weight anionic polymers and copolymers are regularly used as scale inhibitors for cooling water towers and boilers in industry. Comb-shaped copolymer having a backbone and so-called “teeth” attached to the backbone are often used for this purpose.

An example of a comb-shaped copolymers used as scale inhibitors for cooling waters is described in U.S. Pat. No. 5,053,461. This comb-shaped copolymer contains an acrylic ester backbone and “teeth”, which are methacrylic macromonomers. These comb-shaped copolymers are prepared by an aqueous suspension polymerization of a monomer mixture consisting of (1) a macromonomer having a vinyl group at one end of the main chain, and (2) an acrylic ester monomer, in the presence of initiator and a solvent in which the macromonomer is soluble. These polymers are suitable as elastomeric materials, and have excellent transparency, weatherability, and mechanical strength.

Other combed-shaped copolymers are known. For instance, see U.S. Pat. No. 5,424,364, which describes the preparation of polyester/acrylic comb-shaped copolymers using 20-85% of a carboxylic functional polyester copolymer, 10-50% of an oxirane substituted acrylic copolymer, and 2-20% of an imide compound for pigment dispersant applications; U.S. Pat. No. 5,597,871, which describes comb-shaped polymers obtained by free radical polymerization of acrylate monomers with a macromonomer providing the teeth component, e.g. long chain alkyl groups; and U.S. Pat. No. 5,789,503, which describes a method for preparing silicone/organic polymers with varied structures.

The method for synthesizing the comb-shaped copolymers of the '503 patent involves initiating free radical polymerization of a vinyl monomer with an ozonide group bonded to a silane or a siloxane polymer. Polyalkylene oxide-organopolysiloxane comb-shaped copolymers may also be prepared by reaction of organosiloxanes containing diacetoxy end groups as substituents with polyesters containing OH-terminated polyalkylene oxides. U.S. Pat. No. 4,812,364 also discloses their synthesis by the addition of allyl terminated polyalkylene oxides to organopolysiloxanes containing Si—H groups in presence of platinum catalyst.

All citations referred to under this description of the “Related Art” and in the “Detailed Description of the Invention” are expressly incorporated by reference.

### BRIEF SUMMARY OF THE INVENTION

This invention relates to comb-shaped polymers having anionic functionality, which are synthesized by the free radical polymerization of a monomer(s) containing anionic functionality in the presence of a poly (mercaptosiloxane), which functions as a chain-transfer agent. The comb-shaped polymers are selected from the group consisting of polymers represented by the following structural formulae:

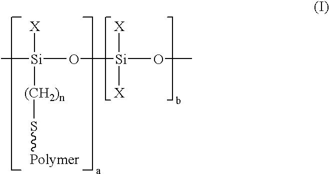

where X=methyl, ethyl, phenyl

n=2 to 6

a=0.1 to 1.0

b=0 to 0.9

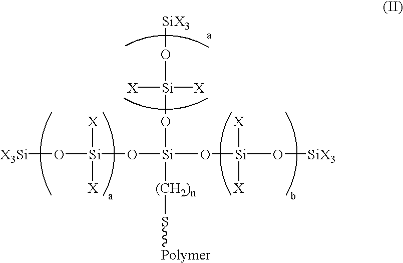

where X=methyl, ethyl, phenyl

n=2 to 6

a=1 to 10

and mixtures thereof, where “polymer” is a homopolymer or copolymer segment derived from one or more monomers that form an anionic polymeric segment, preferably (meth) acrylic acid, and said segment has an average molecular weight of from ˜500 to ˜5,000 as determined by gas permeation chromatography (GPC). The comb-shaped polymers preferably do not have any unreacted —SH groups.

The comb-shaped polymers differ from the prior art because the comb-shaped acrylate polymers of the prior art are typically prepared with vinyl macromonomers as the teeth component or by free radical polymerization of a vinyl monomer initiated by an ozonide group attached to a silane or siloxane polymer.

The polymers are useful as scale inhibitors for cooling water towers and boilers, as water-based pigment dispersants, as pressure-sensitive adhesive, and in low profile composite applications.

### BRIEF DESCRIPTION OF THE SEVERAL VIEWS OF THE DRAWINGS

Not Applicable.

### DETAILED DESCRIPTION OF THE INVENTION

The detailed description and examples will illustrate specific embodiments of the invention, and will enable one skilled in the art to practice the invention, including the best mode. It is contemplated that many equivalent embodiments of the invention will be operable besides these specifically disclosed.

For purposes of describing and claiming this invention, “polymer” includes “copolymers”. The backbone of the comb-shaped polymers is a poly(mercaptosiloxane), which also serves as a chain-transfer agent during the free radical polymerization. The “teeth” of the comb-shaped polymer are monomers or mixtures of monomers having anionic functionality. The comb-shaped copolymers are typically synthesized by precipitation free radical polymerization using toluene as the solvent and an azo initiator. The molecular weight of the polymeric teeth is controlled by the amount of chain-transfer agent used.

The poly(mercaptosiloxanes) are polymeric siloxanes which contain multiple —SH groups. Examples of poly (mercaptosiloxanes) include poly (3-mercaptopropyl) methyl siloxane and its copolymer with poly (dimethylsiloxane), which are commercially available and readily soluble in toluene.

The “teeth” of the comb-shaped anionic polymer are generated by the free radical polymerization of the poly(mercaptosiloxane) chain transfer agent with anionic vinyl monomers under precipitation polymerization conditions. Representative examples of such monomers include acrylic acid, methacrylic acid, 2-acrylamidomethyl propane sulfonic acid (AMPS), itaconic acid, maleic acid and p-styrene sulfonic acid. Other monomers that can be copolymerized with these anionic monomers include, methyl methacrylate, ethyl acrylate, ethyl methacrylate, butyl acrylate, butyl methacrylate, isobutyl acrylate, isobutyl methacrylate, t-butyl acrylate, t-butyl methacrylate, propyl methacrylate, iso-octyl acrylate, 2-hexylethyl acrylate, 2-ethyl hexyl methacrylate, hexyl acrylate, hexyl methacrylate, isopropyl methacrylate, lauryl acrylate, lauryl methacrylate, stearyl acrylate and stearyl methacrylate and combinations thereof.

The synthesis is carried out under precipitation polymerization conditions using an organic solvent and a free-radical initiator. The preferred solvent is toluene. Other solvents that can substitute for all or part of the toluene include xylenes, ethylbenzene, ethyl acetate, butyl acetate and propyl acetate. The reaction is preferably carried out at 60° C.-100° C., and most preferably at 80° C. Continuous addition synthesis is conducted wherein the monomer, initiator and chain transfer agent are independently added to the reactor at the same rate, using metering pumps.

Examples of free-radical initiators include azobis(isobutyronitrile) and 2,2′-azobis(2-methylbutane) nitrile. Peroxide initiators such as benzoyl peroxide may also be used.

When the comonomers become the major component and the anionic monomers the minor component, the polymer product remains in solution in the organic solvent. These solution polymers are useful as pressure sensitive adhesives and coatings.

T-structured poly (mercaptosiloxane) with an acrylate arm can be generated in a similar manner using a mercapto functional, T-structure poly (dimethylsiloxane). The reaction is carried out under precipitation polymerization conditions.

The amount of poly (mercaptosiloxane) chain-transfer agent varies depending on the molecular weight requirement. It is desirable to react all the —SH group of the monomer to avoid odor problems. NMR studies can be used to establish that all the —SH groups are reacted in the synthesis of these comb polymers.

The amount of initiator used is typically 0.1 to 2.0 gram of initiator per 100 grams of monomer.

When the comb-shaped anionic polymers are used as calcium scale inhibitors, they may be typically combined with other known components. For some applications it is preferable to add a water-soluble copolymer to the scale inhibiting composition like phosphinocarboxylic polymer, maleic acid or maleic anhydride polymer, acrylic polymer, methacrylic polymer and their copolymers with sulfonic and/or phosphino functionalities, preferably acrylic/sulfonic copolymers or acrylic/maleic copolymers. Other optional components include phosphonobutane tricarboxylic acid, tolyltriazole, orthophosphate, polyphosphates, hydroxyethylidene diphosphonic acid, amino tri (methylene phosphonic acid).

When the comb-shaped anionic polymers are used as pressure-sensitive adhesives or coatings, additional components may be added to cross-link the polymer. These cross-linking components include metal chelates, epoxy resins, isocyanates, melamine resins and urea-formaldehyde resins.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated.

### Example 1

### Comb-Shaped Poly (Acrylic Acid) by Precipitation Polymerization

In a 4-neck, 1-liter reactor equipped with a condenser, mechanical stirrer, thermocouple, and 3 addition funnels connected to metering pumps and a nitrogen inlet and outlet, 250 g toluene were added. The toluene was heated to 80° C. over a period of 15 minutes under constant nitrogen sweep.

In the meantime, the 3 addition funnels were loaded with 0.13 g of 2,2′-azobis(2-methylbutanenitrile) initiator in 10 ml toluene; 5 g of poly (3-mercaptopropyl) methyl siloxane (supplied by United Chemical Technologies) made up to 10 mL using toluene; and 95 g of acrylic acid respectively.

At the end of the period, an additional 0.43 g of initiator, dissolved in 5-mL toluene, was added to the reactor. The three components in the funnels were added continuously over a period of 2 hours. All three addition funnels were rinsed with 10-mL toluene each. After the addition was complete, the reaction mixture was stirred for another 2 hours at 80° C. Then 0.086 g of initiator was added to the reactor and the reaction was stirred at 90° C. for another hour.

The reaction was then cooled to room temperature and a white fluffy solid product resulted. This product was removed from the reactor and filtered under vacuum using a Buchner funnel. The final polymer was dried in a vacuum oven overnight at 80° C. Detailed ¹³C NMR confirmed the formation of a combed-shaped polymer. The polymer was completely soluble in water in dilute solutions. Foam formation was observed when the aqueous solution was shaken.

### Example 2

### T-Structured poly(mercaptodimethyl siloxane) Polymer Prepared with Acrylic Acid Acid Monomer

The reaction was conducted in a similar manner as Example 1. The chain-transfer agent used in this case was a polydimethyl siloxane, mercapto propyl T-structured branch points¹. Precipitation was observed from the beginning of the reaction. Detailed ¹³C NMR studies of the solid polymer indicates the formation of the T-structured polymer. ¹Supplied by United Chemical technologies.

### Example 3

### Use of Comb-Shaped Copolymer Derived From 2-Ethylhexyl Acrylate and Acrylic Acid Monomers as an Adhesive

To a 500-mL reactor equipped with mechanical stirrer, thermocouple, condenser and an addition funnel, 100 g toluene were charged. The temperature increased to 60° C. under constant nitrogen sweep over a period of half an hour. At the end of that period, 2-ethylhexyl acrylate (44.55 g), acrylic acid (4.95 g) and poly (mercaptopropyl) methyl siloxane (0.5 g) were charged into reactor. Then 0.05 g of VAZO 67 in 10 ml toluene was added slowly to the reactor over a period of 2 hours. After the addition was completed, the temperature increased to 70° C. and the reaction mixture was stirred for 2 hours. The temperature increased to 80° C. and stirring continued for another hour. Finally temperature increased to 90° C. and the reaction was stirred for half an hour.

At the end of reaction, the toluene solution cooled to room temperature and was transferred to a bottle. The solution was tested as a pressure-sensitive adhesive by coating it directly on a Mylar film and drying at 100° C. for 15 min. Then, the 1-mil thick films were evaluated for pressure-sensitive adhesive properties: (1) peel (ASTM D3330-96), (2) tack (ASTM D2979), and (3) shear strength (ASTM D2919).

The results of pressure-sensitive adhesive test are set forth in Table I.

TABLE I

| | |
|---|---|
| 15 min. SS peel: | 2.7-3.0 lb/in, heavy transfer |
| 24 h SS peel: | 2.9-3.1 lb/in, heavy transfer |
| Tack: | 4.1 lb/in², transfer |
| 0.5″ × 0.5″ × 1000 g shear: | Poor |

The tests indicate that the comb-shaped polymer has adequate adhesive properties.

### Example 4

### Use of Comb-Shaped Copolymer Prepared with n-butyl Acrylate and Acrylic Acid Monomers as Adhesive

The reaction was conducted in a similar manner as Example 3. The resulting product was tested as an adhesive. The product was coated on Mylar, dried, and tested as in Example 3. The results are set forth in Table IV.

TABLE II

| | |
|---|---|
| 15 min. SS peel: | 2.6-2.9 lb/in, adhesive transfer |
| Loop tack: | 3.9 lb/in² |
| Adhesive transfer: | 0.5″ × 0.5″ × 1000 g |
| 0.5″ × 0.5″ × 1000 g shear: | <0.02 h |

The tests indicate that the comb-shaped polymer has adequate adhesive properties.

### Example 5

### Test of Comb-Shaped Polymers as Calcium Carbonate Inhibitors

The comb-shaped polymer of Example 1 was tested to determine its effectiveness as a calcium carbonate inhibitor. The test method is described as follows and the test results are set forth in Table III:

The test conditions were set at 600 ppm Ca as CaCO₃, 300 ppm Mg as CaCO₃, pH=9, temperature=60° C. and time=2 h. In order to establish the test conditions, 0.840 g of sodium bicarbonate, and 0.739 g of hydrated magnesium sulfate were weighed out in a 1000 ml volumetric flask. About 500 mL of deionized water was added to dissolve the salts, and the pH was adjusted to a pH=9 by adding 4 drops of 1N NaOH and 3 drops of 50%NaOH. Another 500 mL of water was added to make up solution (A).

Another solution, solution (B), was prepared by adding 8.82 g of hydrated calcium 9 chloride to 100 ml of D.I.water.

One percent solutions of the polymer samples and standard were prepared by weighing out 0.5 g of the polymers and dissolving in 50 ml of water. 50 ml of this solution provides a dosage of 5 ppm, which is the treatment ‘T’. In a 16 ounce plastic bottle, 99 mL of ‘A’, ‘T’ and 1 ml of ‘B’ were added.

The bottles were put in a shaker, previously equilibrated at 60° C., and shaken at level 6 for 2 hours. Belclene 200 was used as the reference material and a control (untreated) and a blank sample were always run in each set. The control has 99 ml of ‘A’ and 1 mL of ‘B’ while the calcium blank is made up of 99 mL distilled water and 1 mL ‘B’.

The hot solutions were filtered through 0.2 micron puradisc filters. The change in calcium concentration after the test was measured by the burette method of titration with EDTA. The percent inhibition was calculated using the formula %inhibition=(Cₜ−C_{c})/(Cᵢ−C_{c}) where:

Cₜ=calcium test, C_{c}=calcium in control and Cᵢ=calcium in blank (Initial concentration)

TABLE III
[Inhibition of calcium carbonate scale by comb-shaped polyacrylic acid]

| Dosage (ppm) | % Inhibition |
|---|---|
| 5 | 46.2 |

Example 5 shows that the comb-shaped polymers inhibit scale formation.

### Test of Comb-Shaped Polymer as Pigment Dispersant

The comb-shaped polymer of Example 1 was tested to determine its effectiveness as a pigment dispersant. The test method is described as follows and the results are set forth in Table IV:

A 70% aqueous dispersion of titanium dioxide is mixed with 0.1% of test dispersant and the Brookfield viscosity measured. About 0.5 ml of a 10% dispersant solution prepared with the comb polymer is added. The test solution is thoroughly mixed using a dispersator and viscosity measured. The test is repeated until viscosity is constant.

TABLE IV
[Comb-poly(acrylic acid) as pigment dispersant]

| Polymer Concentration | |
|---|---|
| (wt/wt TiO₂) | Slurry Viscosity (cps) |
| 0.07 | 20000 |
| 0.14 | 2800 |
| 0.21 | 2600 |
| 0.28 | 2200 |
| 0.35 | 1200 |
| 0.42 | 800 |
| 0.49 | 600 |
| 0.7 | 600 |
| 1.12 | 400 |

The data in Table IV indicate that the comb-shaped polymer is effectively dispersing the TiO₂ pigment.

We claim:

1. A comb-shaped polymer selected from the group consisting of polymers represented by the following structural formulae: 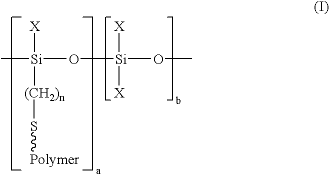
where X=methyl, ethyl, phenyl
n=2 to 6
a=0.1 to 1.0
b=0 to 0.9 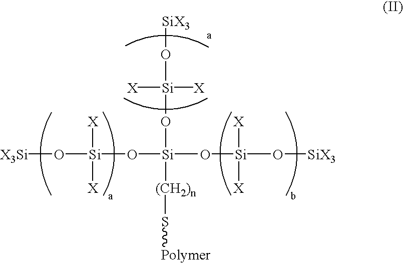
where X=methyl, ethyl, phenyl
n=2 to 6
a=1 to 10
and mixtures thereof, where “polymer” is a homopolymer or copolymer segment derived from one or more monomers that form an anionic polymeric segment, preferably (meth) acrylic acid, and said segment has an average molecular weight of is from ˜500 to ˜5,000 as determined by gas permeation chromatography (GPC).

2. The polymer of claim 1 wherein the chain transfer agent is selected from the group consisting of poly(dimethylsiloxane), poly(3-mercaptopropyl) methyl siloxane, and mixtures thereof.

3. The polymer of claim 1, 2, or 3 wherein the monomer is selected from the group consisting of acrylic acid, methacrylic acid, 2-acrylamidomethyl propane sulfonic acid, itaconic acid, maleic acid and p-styrene sulfonic acid.

4. The polymer of claim 3 wherein the monomer also contains a monomer selected from the group consisting of methyl methacrylate, ethyl acrylate, ethyl methacrylate, butyl acrylate, butyl methacrylate, isobutyl acrylate, isobutyl methacrylate, t-butyl acrylate, t-butyl methacrylate, propyl methacrylate, 2-hexylethyl acrylate, 2-ethyl hexyl methacrylate, hexyl acrylate, hexyl methacrylate, isopropyl methacrylate, lauryl acrylate, lauryl methacrylate, stearyl acrylate, stearyl methacrylate, and mixtures thereof.

5. A process for preparing a comb-shaped anionic polymer comprising reacting a poly(mercaptosiloxane) with a monomer containing anionic functionality in the presence of an azo compound and an organic solvent.

6. The process of claim 5 which comprises the additional step of dispersing the polymer in water and neutralizing with an alkali metal hydroxide or ammonium hydroxide.

7. The process of claim 6 wherein the poly(mercaptosiloxane) is selected from the group consisting of poly(dimethylsiloxane), poly(3-mercaptopropyl) methyl siloxane, and mixtures thereof.

8. The process of claim 7 wherein the monomer is selected from the group consisting of acrylic acid, methacrylic acid, 2-acrylamidomethyl propane sulfonic acid, itaconic acid, acrylamide and p-styrene sulfonic acid and as co-monomers methyl methacrylate, ethyl acrylate, ethyl methacrylate, butyl acrylate, butyl methacrylate, isobutyl acrylate, isobutyl methacrylate, t-butyl acrylate, t-butyl methacrylate, propyl methacrylate, 2-hexylethyl acrylate, 2-ethyl hexyl methacrylate, hexyl acrylate, hexyl methacrylate, isopropyl methacrylate, lauryl acrylate, lauryl methacrylate, stearyl acrylate and stearyl methacrylate.

9. The process of claim 8 wherein the reaction is carried out above ambient temperature.

10. The process of claim 9 wherein the free radical initiator is an azo type initiator.

11. The process of claim 10 wherein the poly(mercaptosiloxane) and free radical initiator are added continuously to the reaction vessel.

12. A comb-shaped anionic polymer prepared in accordance with the process of claim 7, 8, 9, 10, or 11.

13. A calcium carbonate scale inhibitor comprising an effective scale inhibiting amount of the comb-shaped polymer of claims 1, 2, 3, or 4.

14. A process for inhibiting the formation of calcium carbonate scale on a metal surface exposed to an aqueous system comprising:
adding an effective scale inhibiting amount of the comb-shaped polymer of claim 13 to said aqueous system.

15. A pigment dispersion comprising water, a pigment, and an effective dispersing amount of the comb-shaped polymer of claims 1, 2, 3, or 4.

16. A process for dispersing a pigment in an aqueous pigment dispersion comprising:
adding an effective dispersing amount of the comb-shaped polymer of claims 15 to said pigment dipersion.
